(19) United States
(12) Patent Application Publication
(10) Pub. No.: US 2006/0280431 A1
(43) Pub. Date: Dec. 14, 2006

(54) Supporting trick modes in a streaming digital video environment using a root trick mode stream

(76) Inventors: Kirk Blattman, San Ramon, CA (US); Glenn Connery, Petaluma, CA (US); Andrew Palfreyman, San Jose, CA (US)

Correspondence Address: WILSON & HAM, 2530 BERRYESSA ROAD, PMB: 348, SAN JOSE, CA, 95132, US

(21) Appl. No.: 11/445,659

(22) Filed: Jun. 2, 2006

Related U.S. Application Data
(60) Provisional application No. 60/687,253, filed on Jun. 3, 2005.

(51) Int. Cl. H04N 5/91

(52) U.S. Cl. 386/68

(57) ABSTRACT

A technique for supporting trick modes in a streaming digital video environment involves receiving a source stream of digital video content that is encoded for a normal playout rate and generating a root trick mode stream from the source stream, wherein the root trick mode stream is generated for a playout rate that is faster than the normal playout rate. The root trick mode stream is then used to generate subsequent trick mode streams that have faster playout rates than the root trick mode stream. Using a root trick mode stream to generate subsequent trick mode streams requires only one trick mode stream to be generated at ingest and therefore reduces ingest processing requirements and eliminates the need to store a different trick mode stream for every possible trick mode playout rate.

### CROSS-REFERENCE TO RELATED APPLICATIONS

This application is entitled to the benefit of provisional U.S. Patent Application Ser. No. 60/687,253, filed Jun. 3, 2005, the disclosure of which is incorporated by reference herein in its entirety.

### FIELD OF THE INVENTION

The invention relates generally to the streaming of digital video content, and more particularly, to techniques for supporting trick modes in a streaming digital video environment.

### BACKGROUND OF THE INVENTION

Systems that provide real-time streaming of digital video content are being configured to support viewer-initiated control functions such as stop, pause, rewind, fast rewind, and fast forward. With regard to fast rewind and fast forward, a stream of digital video content is provided to the end user that enables the content to be viewed at multiples of the normal playout rate, e.g., 2×, 4×, . . . 30× the normal playout rate. This streaming mode is often called “trick mode” streaming. At the higher playout rates, the digital video content is still recognizable to the viewer, but the action occurs at a faster rate.

Conventionally, one of two approaches has been used to support trick modes in streaming networks. In one approach, referred to generally as “1× output processing,” the original stream of digital video content is retrieved from storage and the picture elements of the stream are processed and filtered for display. Through filtering, some of the elements are discarded (e.g. half the elements for 2× speed) and the remaining elements are streamed to the display system (e.g., a set top box and/or television) for presentation to the viewer. A variation on this approach is to not filter the picture elements, but instead to stream all of the original stream elements (e.g., a 1× stream) to the display system at the higher streaming rate (e.g. 2×), and let the display system process the stream at the higher rate. This approach assumes that the display system supports the higher stream rate. An advantage of the 1× output processing approach is that storage is minimized because only one copy of the stream needs to be stored in the memory of a streaming system. Another advantage is that the processing required at ingest is reduced, which allows more streams to be concurrently ingested by the streaming system. A disadvantage of this approach is that a stream must be retrieved into working storage (e.g., RAM or equivalent) at a rate that is equal to or faster than the trick mode viewing rate. So bandwidth demand on the file system or across the network is multiplied in proportion to the stream trick mode playout rate.

In another approach, referred to generally as “1× input processing,” the original stream of digital video content is preprocessed, typically at the time the stream is ingested into the streaming system, and trick mode streams are concurrently derived from the original stream for each possible trick mode playout rate. Each derived trick mode stream (e.g. 2×, 4', . . . 64×) is stored as a separate stream file. When a trick mode request is made by an end user, the streaming system retrieves the trick mode file corresponding to the requested trick mode playout rate and provides all video elements from the requested trick mode file to the display system of the end user. An advantage of this approach is that only a proportional fraction of the original stream of digital video content needs to be retrieved into working storage and thus the bandwidth requirements of the file system and the distribution network are reduced. A disadvantage of this approach is that each different trick mode stream must be concurrently generated and stored as a separate stream file. Concurrently generating and storing a different trick mode stream for each possible trick mode playout rate consumes a higher quantity of processing and memory resources.

### SUMMARY OF THE INVENTION

A technique for supporting trick modes in a streaming digital video environment involves receiving a source stream of digital video content that is encoded for a normal playout rate and generating a root trick mode stream from the source stream, wherein the root trick mode stream is generated for a playout rate that is faster than the normal playout rate. The root trick mode stream is then used to generate subsequent trick mode streams that have faster playout rates than the root trick mode stream. Using a root trick mode stream to generate subsequent trick mode streams requires only one trick mode stream to be generated at ingest and therefore reduces ingest processing requirements and eliminates the need to store a different trick mode stream for every possible trick mode playout rate. Additionally, using a root trick mode steam to generate subsequent trick mode streams reduces the bandwidth requirement of the storage system.

In an embodiment, more than one root trick mode stream can be generated from the source stream. For example, 2× and 16× root trick mode streams can be generated from the source stream, with the 2× root trick mode stream being used to generate 4× and 8× trick mode streams and the 16× trick mode stream being used to generate 3233 and 64× trick mode streams.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 depicts a distribution network through which digital video content is distributed to end users.

FIG. 2A depicts a stream of digital video content that includes 100% of the stream's GOPs.

FIG. 2B depicts a 2× trick mode stream that includes every other GOP in a stream of GOPs.

FIG. 2C depicts a 16× trick mode stream that includes one out of every sixteen GOPs in a stream of GOPs.

FIG. 3 depicts a functional block diagram of a stream server that may be utilized within the distribution network of FIG. 1.

FIG. 4 illustrates the generation of a root trick mode stream from a source stream and the subsequent generation, from the root trick mode stream, of trick mode streams with faster playout rates than the root trick mode stream.

FIG. 5 depicts a functional block diagram of an embodiment of a trick mode engine that is configured to support tiered trick modes as described with reference to FIG. 4.

FIG. 6 illustrates a case in which two root trick mode streams are generated from a source stream, one at a 2× playout rate and one at a 16× playout rate.

FIG. 7 depicts a functional block diagram of an embodiment of a trick mode engine that is configured to support trick modes as described above with reference to FIG. 6.

FIG. 8 illustrates a case in which 2× and 4× trick mode streams are generated along with an 8× root trick mode stream.

FIG. 9 is a process flow diagram of a method for supporting trick modes in a digital video environment.

FIG. 10 is a process flow diagram of a method for supporting trick modes in a digital video environment.

FIG. 11 is a process flow diagram of a method for supporting trick modes in a digital video environment.

Throughout the description, similar reference numbers may be used to identify similar elements.

### DETAILED DESCRIPTION OF THE INVENTION

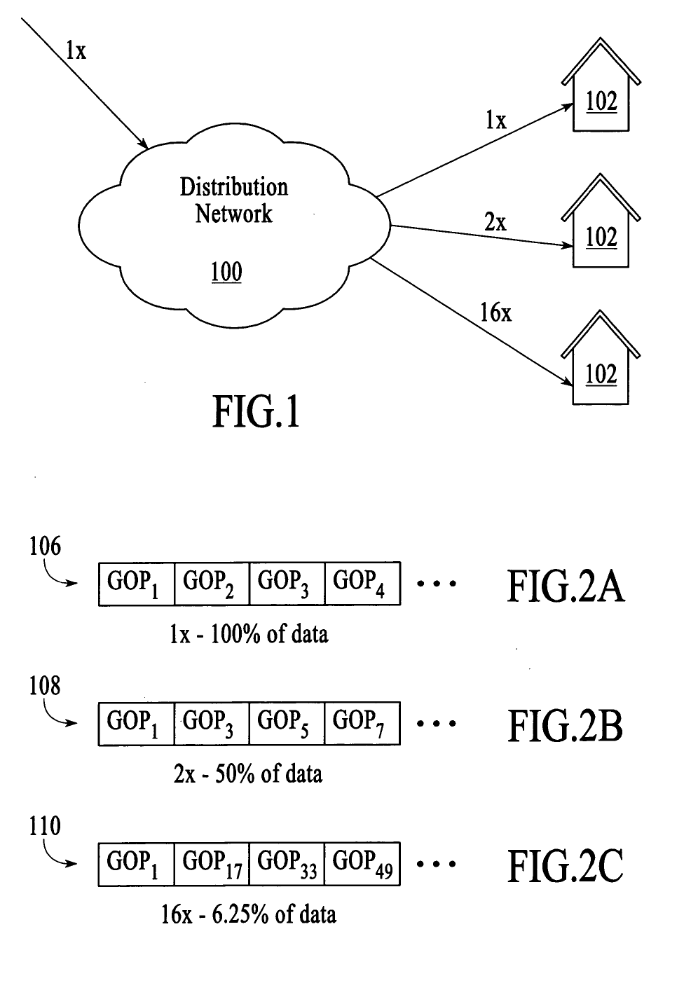

FIG. 1 depicts a distribution network 100 through which digital video content is distributed to end users 102. In the embodiment of FIG. 1, digital video content is ingested into the distribution network at the normal playout rate, identified herein as 1×, where X is the normal playout rate. As is described in more detail below, the digital video content can be distributed to the end users at different playout rates (e.g., 1×, 2×, 16×, etc.)

As used herein, the term “playout rate” refers to the rate at which digital video content appears to be played out to the viewer of the digital video content. For example, at a normal playout rate (e.g., 1×), the digital video content appears to be displayed at normal speed (e.g., in real-time), at a 2× playout rate the digital video content appears to be displayed at twice the normal speed, at a 4× playout rate the digital video content appears to be displayed at four times the normal speed, etc. As used herein, the playout rate is separate and distinct from the transmission rate of a stream. For example, a typical MPEG stream is transmitted to an end user at a rate of 3.75 Mbps. As will be described in more detail below, the average transmission rate of a stream is typically the same regardless of the playout rate of the digital video content.

Using an encoding protocol such as MPEG, digital video content is formatted into groups of pictures (GOPs), with each GOP including an I picture (intracoded picture), P pictures (predictive-coded pictures), and B pictures (bidirectional-coded pictures). FIG. 2A depicts a source stream 106 of digital video content that includes 100% of the original GOPs. A stream with 100% of its GOPs is referred to herein as a 1× stream and will be displayed at a normal playout rate assuming the GOPs are consumed by the display system (e.g., a set top box and/or television) at the standard rate as specified by the MPEG standard. A trick mode with a playout rate of 2× (twice the normal playout rate) can be achieved by generating a trick mode stream that includes only 50% of the GOPs of a 1× stream. FIG. 2B depicts a 2× trick mode stream 108 that includes every other GOP (e.g., GOPs 1, 3, 5, and 7) in a stream of GOPs. Likewise, a trick mode with a playout rate of 16× (sixteen times the normal playout rate) can be achieved by generating a trick mode stream that includes only 6.25% of the GOPs of a 1× stream. FIG. 2C depicts a 16× trick mode stream 110 that includes one out of every sixteen GOPs (e.g., GOPs 1, 17, 33, and 49) in a stream of GOPs. Typically, whether the stream is a 1× stream or a trick mode stream, the stream is still streamed to the end user at approximately the same average rate (e.g., 3.75 Mbps).

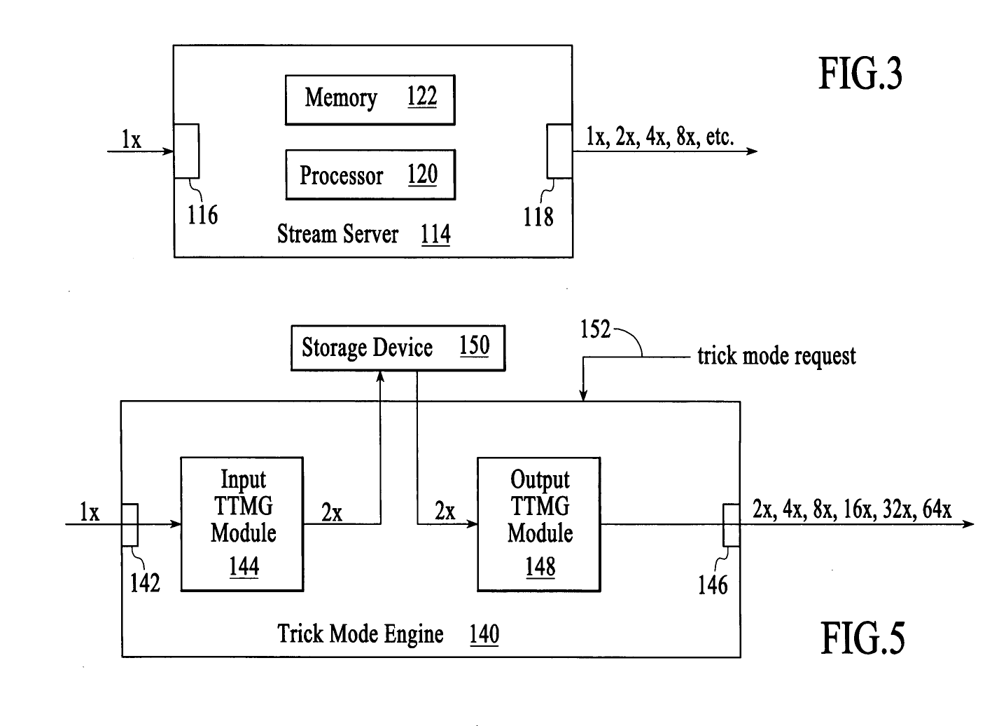

Referring back to FIG. 1, the distribution network 100 may include one or more servers (not shown), referred to herein as stream servers, which manage the ingest of digital video content from a content source and the distribution of digital video content to the end users 102. FIG. 3 depicts a functional block diagram of a stream server 114 that may be utilized within the distribution network of FIG. 1. The stream server includes at least one input interface 116, at least one output interface 118, a processor 120, and memory 122. The input interface receives digital video content, typically a 1× stream that includes 100% of the GOPs as described with reference to FIG. 2A. The processor and memory process and store multiple different streams of ingested digital video content. Streams of digital video content are transmitted to the end users through the output interface and may include streams with a normal playout rate (1×) and/or trick mode streams with playout rates of, for example, 2×, 4×, 8×, etc.

A technique for supporting trick modes in a streaming digital video environment involves receiving a source stream of digital video content that is encoded for a normal playout rate and generating a root trick mode stream from the source stream, wherein the root trick mode stream is generated for a playout rate that is faster than the normal playout rate. The root trick mode stream is then used to generate subsequent trick mode streams that have faster playout rates than the root trick mode stream. Using a root trick mode stream to generate subsequent trick mode streams requires only one trick mode stream to be generated and therefore reduces ingest processing requirements and eliminates the need to store a different trick mode stream for every possible trick mode playout rate. Additionally, using the root trick mode steam to generate subsequent trick mode streams reduces the bandwidth requirement of the storage system.

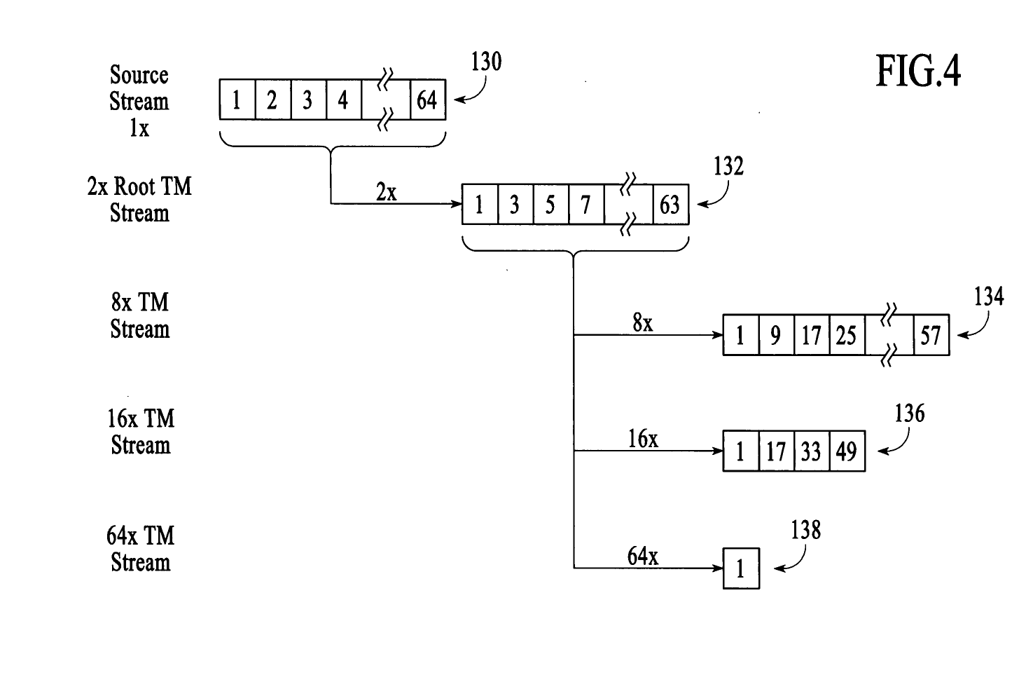

FIG. 4 illustrates the generation of a root trick mode stream 132 from a source stream 130 and the subsequent generation, from the root trick mode stream, of trick mode streams 134, 136, and 138 with faster playout rates than the root trick mode stream. In FIG. 4, the source stream is encoded for a normal playout rate (i.e., it includes 100% of the GOPS) and is depicted as having 64 GOPs, although it should be assumed that the stream likely has more than 64 GOPs. The root trick mode stream is a 2× stream, which includes every other GOP of the source stream. In an embodiment, the root trick mode stream is generated by retaining the odd numbered GOPs of the source stream and discarding the even numbered GOPs of the source stream. The resulting root trick mode stream includes 50% of the GOPs from the source stream. Although in the example of FIG. 4 the odd numbered GOPs of the source stream are retained, other logic can be used to select which GOPs of the source stream are retained. For example, GOPs related to relatively high motion segments of the stream can be retained at a higher density than GOPs related to relatively low motion segments of the stream. In another embodiment, the GOPs are randomly selected from the source stream in order to provide a wider variety of GOPs.

Trick mode streams with different playout rates can be generated from the root trick mode stream by retaining and discarding GOPs of the root trick mode stream in proportion to the desired trick mode playout rate. For example, an 8× trick mode stream can be generated by retaining one out of every four of the GOPs in the root trick mode stream. As illustrated in FIG. 4, the 8× trick mode stream 134 is generated by retaining GOPs 1, 9, 17, 25, . . . 57 of the root trick mode stream 132. A 16× trick mode stream can be generated by retaining one out of every eight of the GOPs in the root trick mode stream. As illustrated in FIG. 4, the 16× trick mode stream 136 is generated by retaining GOPs 1, 17, 33, and 49 of the root trick mode stream. A 64× trick mode stream can be generated by retaining one out of every 32 of the GOPs in the root trick mode stream. As illustrated in FIG. 4, the 64× trick mode stream 138 is generated by retaining GOP 1 of the root trick mode stream. The generation and storage of a root trick mode stream as described with reference to FIG. 4 reduces the processing and storage requirements while still allowing a broad range of trick modes to be supported.

In the example of FIG. 4, GOPs of the root trick mode stream 130 are retained in a fixed repeating pattern such that the first GOP of every four GOPs or the first GOP of every sixteen GOPs is retained to generate 8× and 16× trick mode streams, respectively. It should be understood that other logic can be used to select which GOPs of the root trick mode stream are retained to generate a trick mode stream with a faster playout rate. For example, GOPs related to relatively high motion segments of the root trick mode stream can be retained at a higher density than GOPs related to relatively low motion segments of the root trick mode stream. Alternatively, the GOPs can be randomly selected from the root trick mode stream in order to provide a wider variety of GOPs.

In an embodiment, a stream server such as the stream server 114 depicted in FIG. 3 is configured to support trick modes using the technique described above with reference to FIG. 4. The logic associated with supporting trick modes can be implemented within the stream server in software, hardware, firmware, or any combination thereof. In one embodiment, the trick mode logic is embodied as computer executable code that is stored in the memory of the stream server and executed by the processor of the stream server.

FIG. 5 depicts a functional block diagram of an embodiment of a trick mode engine 140 that is configured to support “tiered” trick modes as described above. The trick mode engine is incorporated into a stream server and includes an input interface 142, an input tiered trick mode group (TTMG) module 144, an output interface 146, and an output TTMG module 148. The trick mode engine is operatively associated with a storage device 150 such as a hard disk drive, RAM, Flash memory, or any combination thereof. In an exemplary operation, a 1× source stream of digital video content is received at the input interface of the trick mode engine. The 1× source stream is processed by the input TTMG module to generate a 2× root trick mode stream. For example, the 2× root trick mode stream is generated by retaining every other GOP of the source stream. Once generated, the 2× root trick mode stream is provided to the storage device.

During the consumption of digital video content by an end user display system, the end user may make a request 152 for a trick mode at a particular playout rate. If the playout rate of the requested trick mode matches the playout rate of the root trick mode stream, then the root trick mode stream is provided to the end user. For example, if a 2× trick mode is requested and the root trick mode stream is a 2× steam, then the root trick mode stream is accessed from the storage device and transmitted through the output interface. If on the other hand, the playout rate of the requested trick mode is faster than the playout rate of the root trick mode stream, then the output TTMG module accesses the root trick mode stream and generates, from the root trick mode stream, a trick mode stream with the requested playout rate. For example, an 8× trick mode stream is generated by retaining one out of every four of the GOPs in the 2× root trick mode stream, a 16× trick mode stream is generated by retaining one out of every eight of the GOPs in the 2× root trick mode stream, and a 64× trick mode stream is generated by retaining one out of every thirty-two of the GOPs in the 2× root trick mode stream. In an embodiment, the requested trick mode stream is generated in real-time in response to the trick mode request.

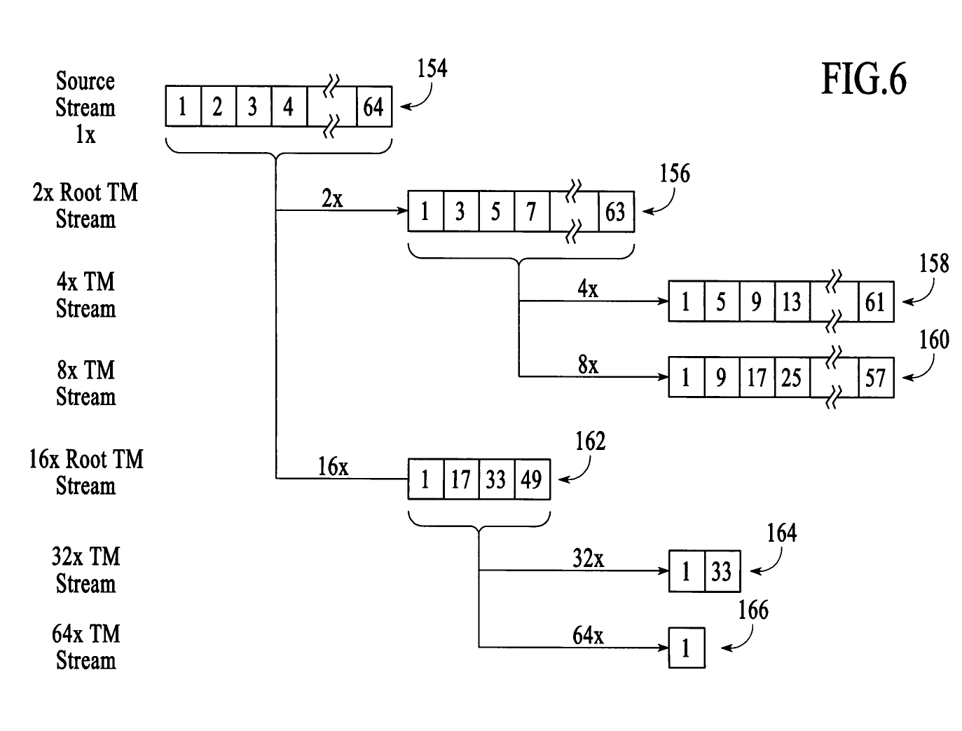

In the examples described with reference to FIGS. 4 and 5, only one root trick mode stream is generated from the source stream. In other embodiments, more than one root trick mode stream can be generated from the source stream. FIG. 6 illustrates a case in which two root trick mode streams 156 and 162 are generated from a source stream 154, one at a 2× playout rate and one at a 16× playout rate. The 2× root trick mode stream can be used to generate trick mode streams 158 and 160 at playout rates of, for example, 4× and 8× while the 16× root trick mode stream can be used to generate trick mode streams 164 and 166 at playout rates of, for example, 32× and 64×. As illustrated in FIG. 6, the 2× root trick mode stream is generated by retaining one out of every two GOPs of the source stream and the 16× root trick mode stream is generated by retaining one out of every sixteen GOPs of the source stream. Further, as illustrated in FIG. 6, the 4× trick mode stream is generated from the 2× root trick mode stream by retaining one out of every two GOPs of the 2× root trick mode stream, the 8× trick mode stream is generated from the 2× root trick mode stream by retaining one out of every four GOPs of the 2× root trick mode stream, the 32× trick mode stream is generated from the 16× root trick mode stream by retaining one out of every two GOPs of the 16× root trick mode stream, and the 64× trick mode stream is generated from the 16× root trick mode stream by retaining one out of every four GOPs of the 16× trick mode stream.

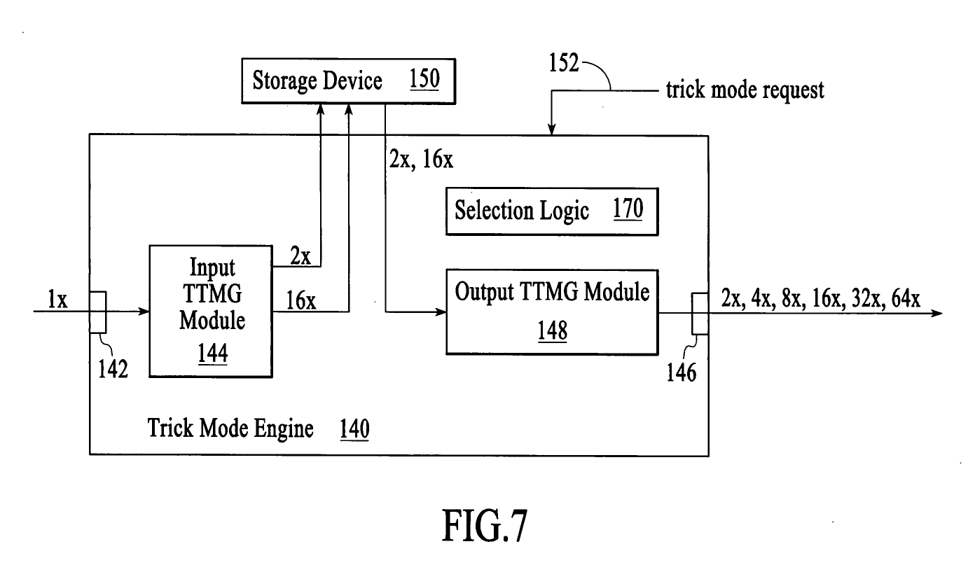

FIG. 7 depicts a functional block diagram of an embodiment of a trick mode engine that is configured to support trick modes as described above with reference to FIG. 6. The trick mode engine 140 of FIG. 6 is the same as the trick mode engine 140 of FIG. 5 except that two root trick mode streams are generated by the input TTMG module 144 instead of just one and the trick mode engine includes selection logic 170 that is configured to select which root trick mode stream is used to service a trick mode request. Referring to FIG. 7, the trick mode engine receives a trick mode request 152 for a trick mode at a particular playout rate. The selection logic evaluates the trick mode request and selects which root trick mode stream should be used to generate the trick mode stream at the requested playout rate. The selected root trick mode stream is then pulled from the storage device and used to generate a trick mode stream at the requested playout rate.

In an embodiment, the selection logic 170 of the trick mode engine maintains a rigid association between the root trick mode streams and the requested trick mode playout rates. For example, referring to FIG. 6, the 4× and 8× trick mode streams 158 and 160 are always generated from the 2× root trick mode stream 156 and the 32× and 64× trick mode streams 164 and 166 are always generated from the 16× root trick mode stream 162. Accordingly, the root trick mode streams are accessed from the storage device 150 based on this rigid association. In another embodiment, the selection logic applies more flexible and dynamic rules to the selection of root trick mode streams. For example, the selection of root trick mode streams can be made in response to various different factors including, for example, the current utilization of the root trick mode streams.

Additionally, a selected root trick mode stream can be changed in mid stream. For example, a 32× trick mode stream may be initially generated from a 2× root trick mode stream and then switched in mid stream to being generated from a 16× root trick mode stream. The root trick mode stream that is used to service a trick mode request may be switched for various reasons. For example, a less optimal root trick mode stream may be temporarily used to generate a trick mode stream instead of a more optimal root trick mode stream because the more optimal root trick mode stream is temporarily unavailable or it is already being heavily accessed.

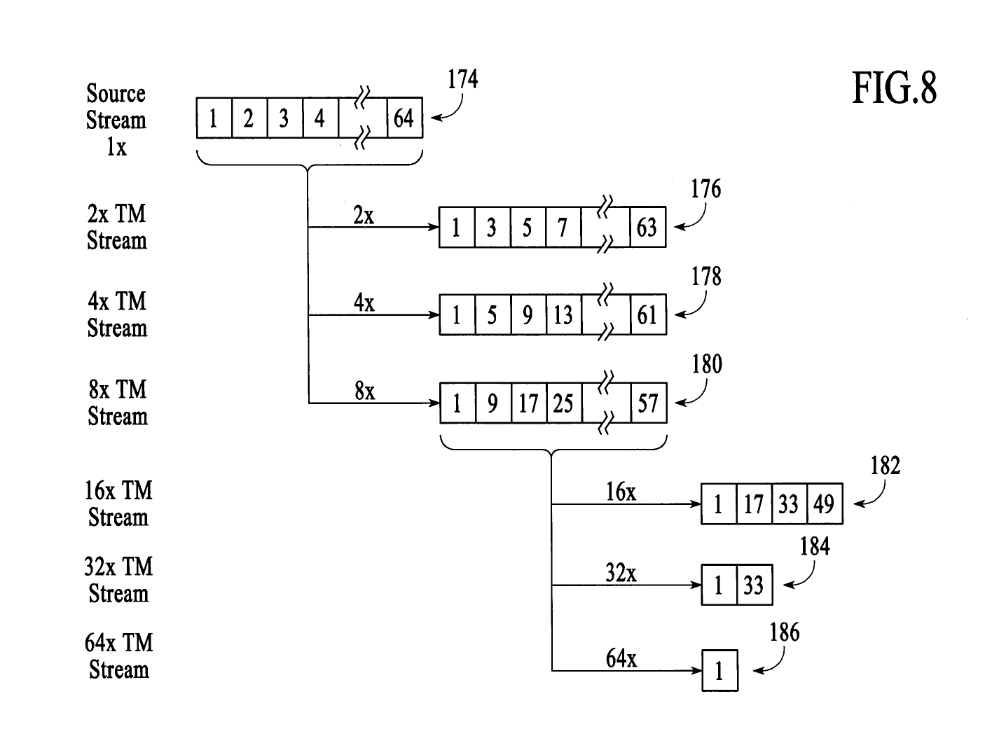

Root trick mode streams can be generated in combination with other trick mode streams at ingest. For example, FIG. 8 illustrates a case in which 2× and 4× trick mode streams 176 and 178 are generated from a source stream 174 at ingest along with an 8× root trick mode stream 180. The 2× and 4× trick mode streams are used to service 2× and 4× trick mode requests, respectively, and the 8× root trick mode stream is used to service 8×, 16×, 32×, and 64×trick mode requests, wherein trick mode streams 182, 184, and 186 are generated from the root trick mode streams.

The trick mode streams that are generated from the root trick mode streams do not have to be integer multiples of the root trick mode streams. For example, a 3× trick mode stream can be generated from a 2× root trick mode stream by discarding one out of every three GOPs in the 2× root trick mode stream.

In an embodiment, root trick mode streams can be generated from other root trick mode streams. For example, a 16× root trick mode stream can be generated from a 2× root trick mode stream instead of from the source stream.

In an embodiment, a digital video streaming system has a fixed number of available trick mode playout rates. For example, the streaming system may offer trick mode playout rates of 2×, 8×, 32×, and 256×. In order to realize the processor and memory resource savings provided by using root trick mode streams, the number of root trick mode streams should be less than the available number of trick mode playout rates and at least one root trick mode stream should have a playout rate that is slower than one of the available trick mode playout rates. In the case where 2×, 8×, 32×, and 256× trick modes are available, there should be fewer than four root trick mode streams and one of the root trick mode streams should have a playout rate of 32× or less.

In an embodiment, root trick mode parameters, including the number of root trick mode streams and the playout rates of the root trick mode streams, are dynamically set in response to operating parameters such as the popularity of a stream, the popularity of trick mode requests, processor utilization, storage utilization, bandwidth utilization, etc. In one embodiment, the playout rates of the root trick mode streams are selected as a function of playout rates of the requested trick modes. For example, the playout rate of the root trick mode stream is set at the most frequently requested trick mode playout rate.

In an embodiment, a trick mode stream can be generated from more than one trick mode stream. For example, a 64× trick mode stream can be generated with GOPs from a 2× root trick mode stream and from a 16× root trick mode stream.

A trick mode engine and a storage device as depicted in FIG. 5 or FIG. 7 can be physically located within the same stream server or within physically separate stream servers that communicate through a network connection. For example, the storage device may be located in a server that is optimized for storage while the trick mode engine is located in a server that is optimized from streaming.

The distribution network 100 supports the streaming (e.g., multicasting and unicasting) of digital video content from stream servers downstream to end users 102. The distribution network also supports upstream unicast messaging from the end users to the stream servers. The streaming network may utilize any network technology that supports the streaming of digital video content to multiple end users. In a packet-based environment, the distribution network may utilize, for example, routers, switches, DSLAMs, cable modem termination systems (CMTSs), passive optical network (PON) architectures, or any combination thereof. In a hybrid fiber coaxial (HFC) environment, the distribution network may utilize, for example, a combination of routers, switches, and QAMs. The distribution network may also utilize wireless distribution technologies.

It should be noted that the rate at which a root trick mode stream must be retrieved from a storage device for output processing is reduced relative to a case in which a trick mode stream is generated directly from the source stream. For example, a 16× trick mode stream derived via output processing from a 1× source stream requires that the 1× source stream be retrieved from the storage device at a 16 times 1× higher speed than the speed required for normal playout (e.g., 3.75 Mbps average data rate must be retrieved at 16*3.75 Mbps or 60 Mbps). By using a root trick mode stream, the retrieval rate from the storage device is reduced. For example, given a 4× root trick mode stream, the retrieval rate from the storage device required to provide the 4× trick mode stream at the 1× rate is simply the 1× rate (e.g., 3.75 Mbps). To generate a 16× trick mode from a 4× root trick mode stream, the root trick mode stream is retrieved from the storage device at four times the 1× rate (e.g., 15 Mbps) instead of sixteen times the 1× rate (e.g., 60 Mbps).

In an embodiment, the rate at which the root trick mode stream is retrieved from the storage device is allowed to vary within defined jitter and rate limits. Jitter can be introduced because of resource congestion during access to auxiliary store (local or network). For example a 32× trick mode stream that is generated from a 16× root trick mode stream can be retrieved from the storage device and played out at a lower rate, for example 1.5×, rather than 2× for extended periods of time during periods of resource congestion. Long term rate modification may also be introduced, and the stream played out at a lower (or higher) average rate for a long period of time.

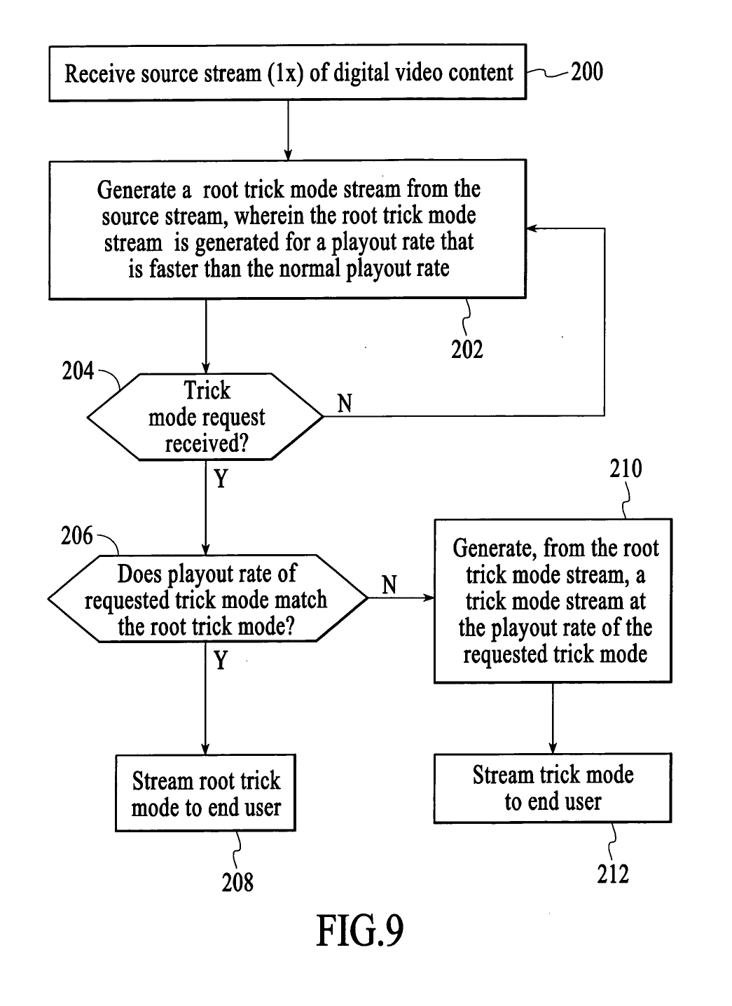

FIG. 9 is a process flow diagram of a method for supporting trick modes in a digital video environment. At block 200, a source stream of digital video content at a 1× playout rate is received. At block 202, a root trick mode stream is generated from the source stream, wherein the root trick mode stream is generated for a playout rate that is faster than the normal playout rate. At decision point 204, it is determined whether or not a trick mode request has been received. If a trick mode request has not been received then the process returns to block 202. If a trick mode request has been received then at decision point 206 it is determined whether or not the playout rate of the requested trick mode matches the root trick mode. If the playout rate of the requested trick mode matches the playout rate of the root trick mode, then at block 208 the root trick mode stream is streamed to an end user. If the playout rate does not match the playout rate of the root trick mode, then at block 210, a trick mode stream at the playout rate of the requested trick mode is generated from the root trick mode. At block 212, the generated trick mode stream is streamed to the end user.

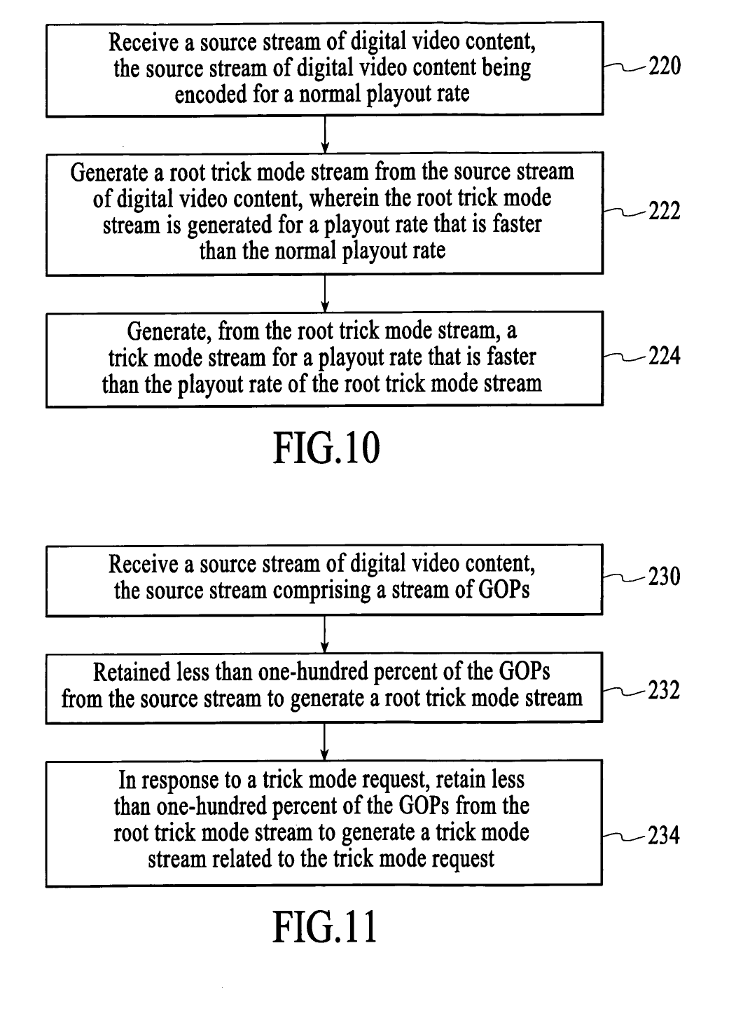

FIG. 10 is a process flow diagram of a method for supporting trick modes in a digital video environment. At block 220, a source stream of digital video content is received, the source stream of digital video content being encoded for a normal playout rate. At block 222, a root trick mode stream is generated from the source stream of digital video content, wherein the root trick mode stream is generated for a playout rate that is faster than the normal playout rate. At block 224, a trick mode stream for a playout rate that is faster than the playout rate of the root trick mode stream is generated from the root trick mode stream.

FIG. 11 is a process flow diagram of a method for supporting trick modes in a digital video environment. At block 230, a source stream of digital video content is received, the source stream comprising a stream of GOPs. At block 232, less than one-hundred percent of the GOPs are retained from the source stream to generate a root trick mode stream. At block 234, in response to a trick mode request, less than one-hundred percent of the GOPs are retained from the root trick mode stream to generate a trick mode stream related to the trick mode request.

Although the streams of digital video content are depicted and described in terms of GOPs, the streams of digital video content can be formatted into other content elements. Additionally, root trick mode stream and trick mode streams can be generated by retaining and/or discarding content elements of a stream other than on a per-GOP basis. For example, it may be possible to retain and discard content elements at the picture level instead of the GOP level. In an embodiment, GOPs retained in root trick mode stream may include all of the original pictures of the GOP, only some of the original pictures, and/or added pictures. For example, some P or B pictures may be removed from a GOP, or additional pictures may be added to a GOP to enhance the quality of the resulting video display.

Although specific embodiments of the invention have been described and illustrated, the invention is not to be limited to the specific forms or arrangements of parts as described and illustrated herein. The invention is limited only by the claims.

What is claimed is:

1. A method for supporting trick modes in a digital video environment, the method comprising:
receiving a source stream of digital video content, the source stream of digital video content being encoded for a normal playout rate;
generating a root trick mode stream from the source stream of digital video content, wherein the root trick mode stream is generated for a playout rate that is faster than the normal playout rate; and
generating, from the root trick mode stream, a trick mode stream for a playout rate that is faster than the playout rate of the root trick mode stream.

2. The method of claim 1 wherein the source stream is comprised of a stream of group of pictures (GOPs) and wherein generating the root trick mode stream comprises discarding GOPs from the source stream.

3. The method of claim 2 wherein generating the trick mode stream from the root trick mode stream comprises discarding GOPs from the root trick mode stream.

4. The method of claim 1 further comprising generating, from the root trick mode stream, different trick mode streams with different playout rates.

5. The method of claim 1 further comprising establishing a number of available trick mode playout rates and generating multiple root trick mode streams, wherein the number of root trick mode streams generated is less than the number of available trick mode playout rates.

6. The method of claim 1 further comprising dynamically setting the number of root trick mode streams to generate in response to an operating parameter.

7. The method of claim 1 further comprising dynamically setting the playout rate of the root trick mode stream in response to an operating parameter.

8. The method of claim 1 further comprising generating a second root trick mode stream from the source stream and wherein generating the trick mode stream comprises generating the trick mode stream from the root trick mode stream and then switching to generating the trick modes stream from the second root trick modes stream.

9. The method of claim 8 wherein generating the trick mode stream from more than one root trick mode stream comprises randomizing the selection of GOPs from the more than one root trick mode stream.

10. A method for supporting trick modes in a digital video environment, the method comprising:
receiving a source stream of digital video content, the source stream of digital video content being encoded for a normal playout rate;
generating a root trick mode stream from the source stream of digital video content, wherein the root trick mode stream is generated for a playout rate that is faster than the normal playout rate;
receiving a request for a trick mode at a playout rate that is different from the playout rate of the root trick mode stream; and
in response to the request for a trick mode, generating, from the root trick mode stream, a trick mode stream for the playout rate of the requested trick mode.

11. The method of claim 10 wherein the source stream is comprised of a stream of group of pictures (GOPs) and wherein generating the root trick mode stream comprises discarding GOPs from the source stream.

12. The method of claim 11 wherein generating the trick mode stream from the root trick mode stream comprises discarding GOPs from the root trick mode stream.

13. The method of claim 10 further comprising generating, from the root trick mode stream, different trick mode streams with different playout rates.

14. The method of claim 10 further comprising establishing a number of available trick mode playout rates and generating multiple root trick mode streams, wherein the number of root trick mode streams generated is less than the number of available trick mode playout rates.

15. The method of claim 10 further comprising dynamically setting the playout rate of the root trick mode stream in response to an operating parameter.

16. A system for supporting trick modes in a digital video environment, the system comprising:
a trick mode engine configured to:
generate a root trick mode stream from a source stream of digital video content, wherein the source stream is encoded for a normal playout rate and the root trick mode stream is generated for a playout rate that faster than the normal playout rate;
receive a request for a trick mode at a playout rate that is different from the playout rate of the root trick mode stream; and
in response to the request for a trick mode, generate, from the root trick mode stream, a trick mode stream for the playout rate of the requested trick mode.

17. The system of claim 16 wherein the source stream is comprised of a stream of group of pictures (GOPs) and wherein the trick mode engine is further configured to generate the root trick mode stream by removing GOPs from the source stream.

18. The method of claim 17 wherein the trick mode engine is further configured to generate the trick mode stream from the root trick mode stream by discarding GOPs from the root trick mode stream.

19. A method for supporting trick modes in a digital video environment, the method comprising:
receiving a source stream of digital video content, the source stream comprising a stream of groups of pictures (GOPs);
retaining less than one-hundred percent of the GOPs from the source stream to generate a root trick mode stream; and
in response to a trick mode request, retaining less than one-hundred percent of the GOPs from the root trick mode stream to generate a trick mode stream related to the trick mode request.

20. The method of claim 19 further comprising using the root trick mode stream to generate different trick mode streams having different playout rates.
